(19) United States
(12) Patent Application Publication
(10) Pub. No.: US 2013/0046509 A1
(43) Pub. Date: Feb. 21, 2013

(54) MULTI-CORE PROCESSOR TEST SYSTEM AND METHOD

(71) Applicants: Ramakrishna C. Dhanekula, Carlsbad, CA (US); Kenny C. Gross, San Diego, CA (US); David Keith McElfresh, San Diego, CA (US)

(72) Inventors: Ramakrishna C. Dhanekula, Carlsbad, CA (US); Kenny C. Gross, San Diego, CA (US); David Keith McElfresh, San Diego, CA (US)

(73) Assignee: ORACLE INTERNATIONAL CORPORATION, Redwood City, CA (US)

(21) Appl. No.: 13/213,883

(22) Filed: Aug. 19, 2011

(51) Int. Cl. G06F 11/30

(52) U.S. Cl. 702/186

(57) ABSTRACT

Systems and methods for testing a multi-core processor may include comparing electromagnetic energy radiated from the multi-core processor while executing a specified set of instructions to reference values associated with multi-core processors having known numbers of operable cores. In various embodiments, average radiated power at a plurality of selected frequencies is compared to corresponding reference values to determine the number of functioning cores. In one embodiment, similarity between a test node and one or more reference nodes is determined using a Euclidean distance. The number of operable cores is determined according to a known number of operable cores associated with the closest reference node.

### TECHNICAL FIELD

This disclosure relates to testing functionality of multi-core processors and similar integrated circuits.

### BACKGROUND

Processors often include multiple blocks, sometimes referred to as cores. Each core may be capable of concurrently executing at least some of the program code. By having multiple cores concurrently executing program code, the overall execution speed of programs on a multi-core processor may be greater than that of a single core processor. Multi-core processors may be implemented on a single integrated circuit (IC). While implementing multiple cores on a single IC may be advantageous in terms of increased processing speed, it may present new challenges in terms of ensuring that the IC is functional.

Various test strategies may be used to determine IC functionality. One technique includes designing the IC with dedicated package pins and/or shared diagnostic/functional pins used for testing. As IC manufacturing technology provides the ability to make smaller and more densely packed circuit elements with a larger number of cores, it is increasingly more difficult to provide a sufficient number of pins for the desired diagnostic testing due to the limited pin-out space available in a particular chip package.

Regardless of the type of testing strategy used, detection of one or more non-functioning cores has generally resulted in discarding the entire chip. However, the ability to detect and identify non-functioning cores may be used to salvage the chip for use in less demanding applications with reduced core-set functionality and thereby increase effective chip yield.

### SUMMARY

A system or method for testing functionality of a processor may include a controller configured to determine a number of operable cores of the processor based on detected electromagnetic energy radiated by the processor while the processor executes a specified set of instructions.

Embodiments of systems and methods for testing a processor, such as a multi-core processor, according to the disclosure may include executing a specified set of instructions using the multi-core processor, measuring electromagnetic energy radiated from the multi-core processor while executing the specified set of instructions, determining a test node corresponding to radiated power at each of a plurality of predetermined frequencies of the radiated electromagnetic energy, and comparing the test node to each of a plurality of reference nodes with each reference node corresponding to a known number of operating cores of a reference multi-core processor executing the specified set of instructions to determine a number of functional cores in the multi-core processor. In one embodiment, a system or method includes determining a number of operable cores of the multi-core processor by determining an average signal strength of the radiated electromagnetic energy at each of the plurality of frequencies. Systems or methods may also include determining a weighting factor for each of the plurality of frequencies and applying a corresponding weighting factor to the average signal strength for each of the plurality of frequencies. The weighting factor may be calculated to attenuate signals at frequencies that have more noise relative to other available frequencies. In one embodiment, a normalized weighting factor is determined based on an inverse variance of radiated electromagnetic energy for each frequency relative to an inverse of a sum of variances for all of the plurality of frequencies for a reference multi-core processor. Embodiments according to the present disclosure may also include comparing a test node to each of a plurality of reference nodes by determining a Euclidean distance in a multi-dimensional feature space between the test node and each reference node. The number of functional cores may then be determined by the reference node closest to the test node based on the Euclidean distance.

Systems or methods for testing a processor according to the present disclosure may provide various advantages relative to conventional testing strategies. For example, various embodiments of the present disclosure may determine the number of functioning cores of a processor using radiated electromagnetic energy so that dedicated pin-outs and associated package cost/complexity are reduced or eliminated. While various systems and methods according to the present disclosure provide reduced cost/complexity of dedicated pin-outs for even a modest number of cores in a multi-core processor, reducing or eliminating pin-outs for testing becomes increasingly more important as the number of cores continues to grow. Identification of inoperable or defective cores based on a radiated electromagnetic signature or fingerprint may reduce chip fabrication testing and quality assurance costs, conserve package pin-outs, and increase effective chip yields by salvaging chips for use in applications with reduced core-set functionality.

The above advantages and other advantages and features associated with various embodiments of the present disclosure will be readily apparent from the following detailed description when taken in connection with the accompanying drawings.

### BRIEF DESCRIPTION OF THE DRAWINGS

FIGS. 1 and 2 are plots of signals from radiated electromagnetic energy at selected frequencies for reference multi-core processors having different numbers of operable cores;

FIG. 3 is a flow chart illustrating operation of a system or method for determining a weighting factor according to various embodiments of the present disclosure;

FIGS. 4 and 5 illustrate normalized signal strength for the reference multi-core processors of FIGS. 1 and 2, respectively, and a representative multi-core processor being tested;

FIG. 6 is a graph illustrating a combined normalized signal strength at the two frequencies of FIGS. 4-5 for reference nodes corresponding to processors with known numbers of operable cores relative to a representative test node of a multi-core processor being tested;

FIG. 7 is a graph illustrating reference nodes and a test node generated using three test frequencies;

FIG. 8 is a flow chart illustrating operation of a system or method for determining a number of operable cores based on a normalized signal strength according to various embodiments of the present disclosure;

FIG. 9 is a flow block diagram of a test arrangement for a multi-core processor; and

FIG. 10 is a flow chart illustrating operation of a system or method for testing a processor according to various embodiments of the present disclosure.

### DETAILED DESCRIPTION

Embodiments of the present disclosure are described herein; however, it is to be understood that the disclosed embodiments are merely exemplary and other embodiments may take various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the Figures may be combined with features illustrated in one or more other Figures to produce embodiments that are not explicitly illustrated or described. The combinations of features illustrated provide representative embodiments for typical applications. However, various combinations and modifications of the features consistent with the teachings of this disclosure may be desired for particular applications or implementations.

As previously described, integrated circuits (ICs) are generally tested in a variety of ways prior to their deployment in an electronic device. Traditional methods of testing a single core processor include providing testing signal patterns to certain pins of the IC and detecting core response via other pins of the IC. As the number of cores on a processor increases however, there may be an insufficient number of pins to dedicate to each core for testing purposes. As recognized by those of ordinary skill in the art, additional cores may be implemented on an IC without necessarily increasing the number of IC pins as there are engineering benefits to minimizing the number of IC pins.

Multi-core processors (processors with more than one core) with reduced core-set functionality (one or more inoperable cores) may be packaged and sold. This practice, however, may require an identification of the number of operable (or inoperable) cores on the multi-core processors. In the representative embodiments illustrated and described herein, a multi-core processor includes six (6) cores. However, the systems and methods of the present disclosure may be applied to integrated circuits having a greater or lesser number of cores. Similarly, testing strategies according to the present disclosure may be applied to other types of integrated circuits to detect operation of blocks of elements that exhibit a particular electromagnetic signature or fingerprint during operation.

According to the present disclosure, the radiated electromagnetic (EM) energy exhibited by an integrated circuit having a multi-core processor or other type of functional blocks may be used to determine the number of operable (or inoperable) cores or blocks. An electromagnetic energy detector, such as an antenna (or the like) may be positioned proximate to the integrated circuit to detect the radiated electromagnetic energy by a multi-core processor in response to executing known instructions. The detected EM energy may be analyzed and compared, for example, to reference values corresponding to ICs having differing numbers of operable (or inoperable) blocks or cores. The closest reference value or reference node may be used to indicate the number of operable (or inoperable) blocks or cores of the IC under test. Such an arrangement may reduce fabrication and quality test costs.

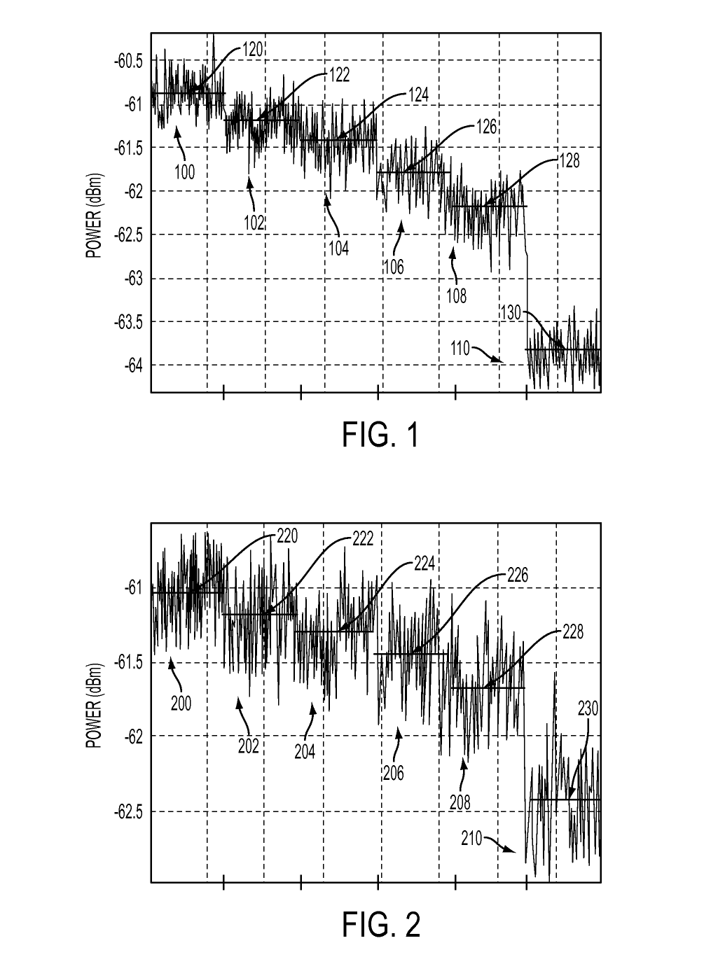

FIGS. 1 and 2 illustrate signals corresponding to radiated EM energy for ICs having multi-core processors with a known number of operable cores while executing a specified set of test instructions. The plots illustrate signal strength in dBm relative to a number of samples or observations. As generally understood by those of ordinary skill in the art, dBm is an abbreviation for the power ratio in decibels (dB) of the measured power referenced to one milliwatt (mW). Of course, the signal strength may be expressed in various other manners depending on the particular application and implementation.

Signals associated with radiated electromagnetic energy for one or more ICs having multi-core processors with a known number of functioning cores are processed to obtain a reference or library data set of signatures or fingerprints for use during testing. In one embodiment, broad spectrum radiofrequency signals are captured using an antenna positioned proximate to the IC. Positioning of an antenna or other EM detector may vary depending on the particular type of antenna/detector and the level of ambient EM noise/interference of the testing facility or location. The signals may then be processed to extract signal information for frequencies (or frequency bands) of interest using a fast Fourier transform (FFT) or similar processing strategy, for example. The number of frequencies or frequency bands and the particular frequencies of interest may be selected for a particular application and/or specified set of test instructions or operations as described in greater detail herein.

FIG. 1 illustrates representative reference signals 100-110 for a first frequency of interest corresponding to about 612 MHz while FIG. 2 illustrates representative reference signals 200-210 for a second frequency of interest corresponding to about 622 MHz. A single multi-core processor may be used with different numbers of cores disabled to establish the reference values. Alternatively, different multi-core processors with known numbers of operable cores may be used. Signals may be averaged or otherwise combined from a group of reference ICs to improve statistical significance of the reference or library data sets or reference nodes. Signals 100, 200 are reference signals corresponding to six (6) operating cores. Similarly, signals 102, 202 correspond to five (5) operating cores, signals 104, 204 correspond to four (4) operating cores, signals 106, 206 correspond to three (3) operating cores, signals 108, 208 correspond to two (2) operating cores, and signals 110, 210 correspond to one (1) operating core. The signals are collected while the processors execute a specified set of test instructions. While the testing strategy of the present disclosure may also be used while the processor is at idle in some applications, specified test instructions may be selected to load all of the processor cores as this generally results in more radiated EM energy, which will improve signal to noise ratio (SNR) of the resulting measurements. In one embodiment, the specified set of instructions is also used to assess the thermal operating characteristics or performance of the IC. Multiple sets of instructions may be used to generate corresponding reference information and test information depending on the particular application and implementation.

After frequency based processing of the signals to extract signal level information at one or more frequencies of interest, various other statistical processing may be performed to provide the reference values or nodes. As used herein, a reference node includes a data set or array of values (that may contain only a single value) that functions as a signature or fingerprint for a particular number of operating IC functional blocks or cores. For example, a reference node for six (6) operating cores of a multi-core processor executing a designated set of instructions may include average signal levels at one or more frequencies. Of course, other signal characteristics may also be used alone or in combination to determine a particular reference node, such as variance, standard deviation, maximum value, minimum value, etc. The same signal processing is performed for the IC being tested to establish a test node, data set, or array, which is then compared to the reference nodes to determine the number of operable/inoperable blocks or cores of the IC being tested as described in greater detail herein.

Testing has revealed that the accuracy of a core functionality assessment based on signals corresponding to the radiated EM energy increases when data at several different frequencies are used. In one embodiment, data taken at 20 different selected frequencies have been found to yield accurate results. Of course, the number of frequencies and the particular frequencies selected may vary by application and implementation. In one embodiment, frequencies are selected by performing a cross-correlation analysis of frequencies having a signal level above a threshold with each signal/frequency compared or correlated with all of the other signals/frequencies to identify frequencies with best correlation. Empirical results may then be used to select the number of frequencies to provide a desired confidence level in the resulting determination of the number of operational cores. Other criteria or constraints may also be used in selecting the particular frequencies for measurements to reduce or eliminate ambiguity in determining the number of operational cores, i.e. selecting those frequencies that provide radiated EM power measurements with adequate separation for each reference node relative to adjacent reference nodes. As illustrated in FIG. 1, for example, the selected frequency provides a separation (or difference) between mean values 120 and 122 sufficient to unambiguously determine the number of associated operable cores. However, if values 120 and 122 were closer together, and/or if the noise associated with corresponding signals 100, 102 were much greater, it is possible that the measurements would be ambiguous with respect to whether a particular measurement indicated five (5) operable cores or six (6) operable cores.

Frequency selection criteria may vary depending on the particular signal characteristic measured. In one embodiment, a frequency selection constraint is used to select only those frequencies that have distinct radiated EM power levels such that each power level is separated from the next adjacent power level by at least 0.5 times the greatest standard deviation for any node. In other words, for the representative values illustrated in FIG. 1, the standard deviation is computed for time series signals 100, 102, 104, 106, 108, and 110 to determine a corresponding maximum standard deviation (STD_Max). The selected signal characteristic (average or mean signal strength in this example) associated with a particular number of operating cores is then compared to the signal value associated with adjacent numbers of operable cores. The particular frequency being considered meets the selection criteria and may be used for subsequent testing if the difference between any adjacent reference measurements exceeds (0.5*STD_Max), i.e. the difference between mean value 122 and mean value 120 exceeds (0.5*STD_Max as well as the difference between mean value 122 and mean value 124 etc. for each core.

As apparent from FIGS. 1 and 2, various signal characteristics of signals 100-110 and 200-210 may be indicative of the number of functioning cores. For example, the average signal strengths represented in FIG. 1 by lines 120-130 and in FIG. 2 by lines 220-230 generated in response to executing the same set of instructions varies with the number of operable (or inoperable) cores. Moreover, testing has revealed that the average signal strengths (at a particular frequency) associated with processors each having the same number of operable cores and executing the same set of instructions is well correlated. As such, the average signal strength for radiated EM energy produced by a multi-core processor with an unknown number of operable cores in response to executing the specified set of instructions can be compared with, for example, the average signal strengths of FIGS. 1 and/or 2 to determine the number of operable (or inoperable) cores.

In some embodiments, selected signal frequencies that exhibit more noise for a particular instruction set or processor may be detuned or de-emphasized when establishing the corresponding reference nodes and test node. For example, a different dynamic weighting factor based on a measure of noise at each frequency may be applied to the signal at that frequency. Frequencies having the greatest noise may be assigned less weight relative to frequencies having the least noise. Representative measures of noise that may be used in determining the weighting factors include standard deviation and variance, for example.

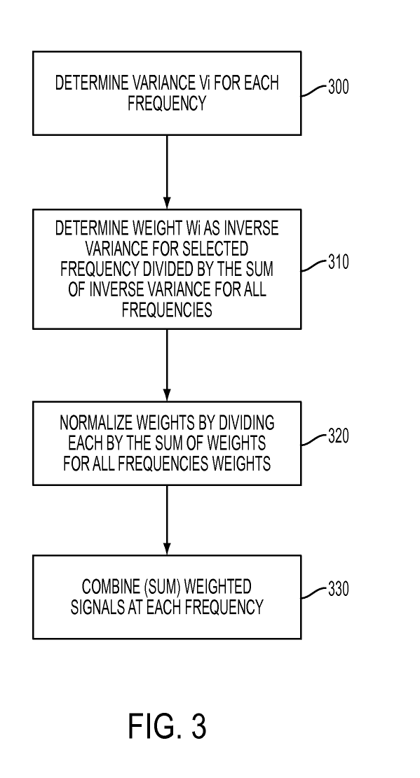

FIG. 3 illustrates a representative strategy for determining dynamic weighting factors to effectively reduce the influence of the noisiest signals while selectively enhancing the influence of the best (least noisy) signals. The dynamic weighting factors are applied to each of the signals for each of the selected frequencies. The weighting factors in this embodiment correspond to the inverse variance for each of the signals at the frequencies selected for measurement/processing. As generally represented by block 300, the variance V, is determined for each frequency or frequency range/bin, where i is indexed from 1 to the desired number of frequencies or frequency ranges/bins (N). In one embodiment N=20 frequencies of interest. The weighting factor for each frequency is then determined as represented by block 310 according to:

wᵢ=[1/Vᵢ]/[1/V] where V=sum of variances of all the selected frequencies.

As also illustrated in FIG. 3, the weights wᵢ are normalized by dividing each by the sum of all the weights as represented by block 320 and:

Wᵢ=wᵢ/Σwᵢ for i=1 to N frequencies,

where Wᵢ represents the normalized weighting factor for frequency i. The resulting reference or test node may then be determined by combining the weighted signals at each of the selected frequencies as represented by block 330. The test node signature or fingerprint is then compared to reference nodes each having a known number of operable cores using a pattern matching process to determine the number of operable cores of the processor or IC being tested.

In one embodiment, a comparison or pattern matching strategy is implemented to determine the similarity between the test signal and reference signals each associated with a known number of operable cores. A matching (or most similar) reference node is selected to determine the number of operating cores of the test IC. Various strategies may be used to determine the similarity or degree of matching between the test nod and reference nodes. In one embodiment, a single or multi-dimensional Euclidean distance (straight line or L₂ distance) between the test node and each of the reference nodes is determined. The number of operating cores in the test IC is determined based on the number of cores associated with the reference node having the shortest distance to the test node. Of course, other strategies for determining similarity between the test node and reference nodes may also be used. For example, the Bray-Curtis index determined by subtracting the Bray-Curtis dissimilarity from 100 may be used. Alternatively, or in combination, a chi-squared distance or L₁ (city-block or Manhattan) distance (corresponding to the sum of absolute differences between a test node and reference node) may be used.

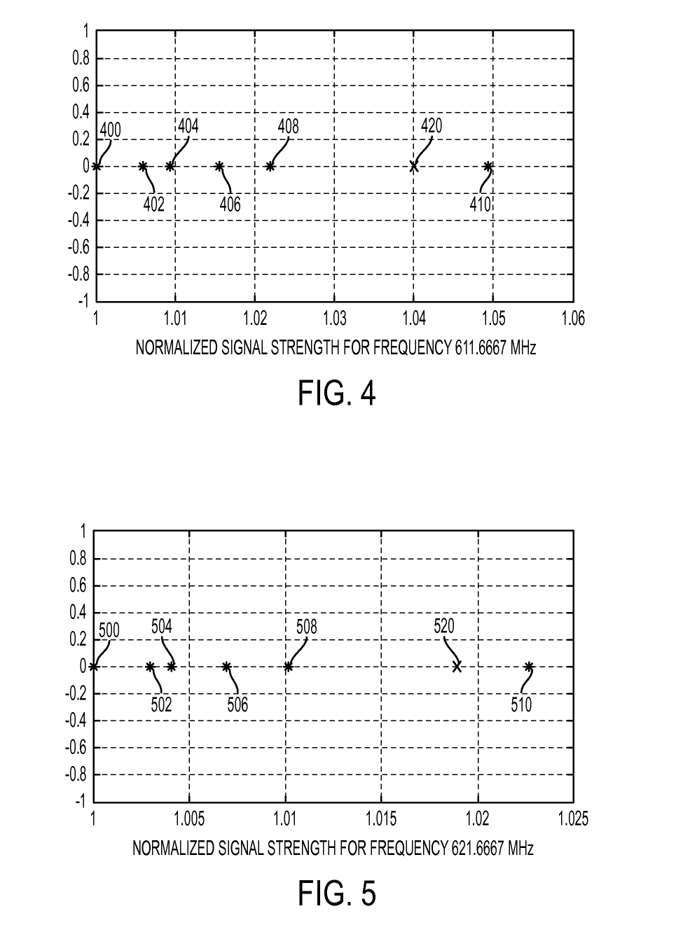

FIGS. 4-8 illustrate a representative matching process implemented using a multi-dimensional distance calculation as a measure of similarity according to one embodiment of the present disclosure for automated identification of operable cores in a high-throughput chip fabrication facility. The average (or mean) power values for a six-core processor chip were previously illustrated and described with reference to FIGS. 1 and 2. The average power values with N cores operational, where N takes on the values 6, 5, 4, 3, 2, and 1, can be normalized by dividing each by the signal power associated with all 6 cores operational, for example. This results in a normalized value of 1.00 when all six cores are operable as represented by reference node 400 in FIG. 4 and reference node 500 in FIG. 5. The resulting normalized reference nodes from the signals of FIG. 1 corresponding to a frequency of about 612 MHz are plotted in FIG. 4, with normalized reference nodes 402, 404, 406, 408 and 410 corresponding to signals 102-110 of FIG. 1. Similarly, the resulting normalized reference nodes from the signals 202-210 of FIG. 2 corresponding to a frequency of about 622 MHz are represented by nodes 502, 504, 506, 508, and 510, respectively, in FIG. 5.

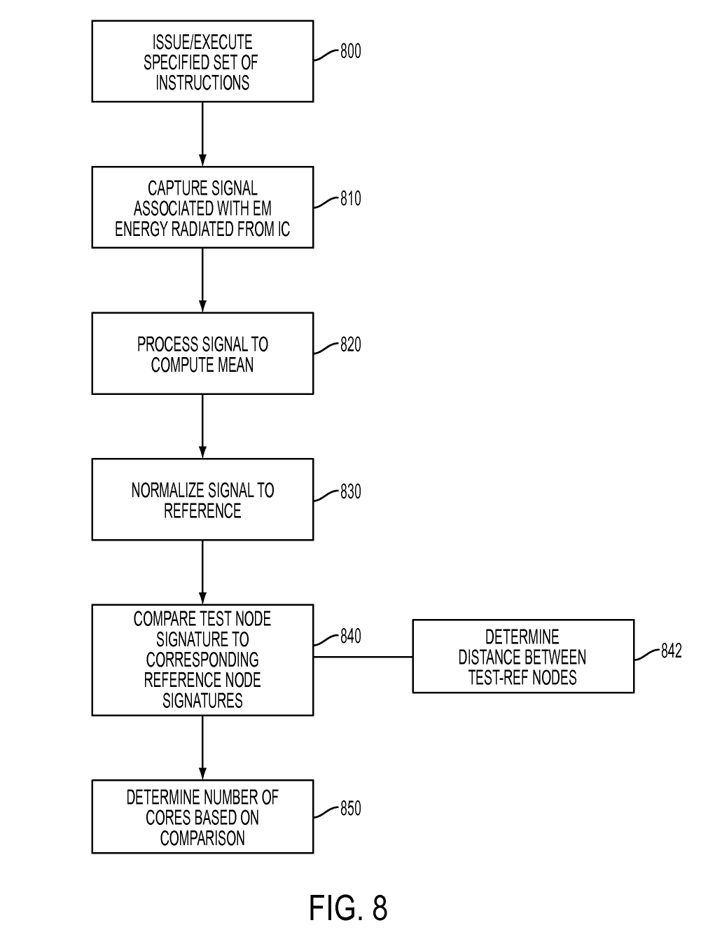

Using the normalized reference nodes from FIG. 4 and/or FIG. 5, the number of operational cores in a test IC can be determined by comparing a test node computed in an analogous fashion to each of the reference nodes to identify the number of operational cores as illustrated in the block diagram of FIG. 8. For example, in one embodiment, an IC being tested executes a specified set of instructions as represented by block 800 (FIG. 8). A signal associated with radiated EM energy at one or more frequencies of interest is captured by an antenna or other EM sensor proximate to the IC being tested as represented by block 810 (FIG. 8). The test signal is processed in an analogous fashion as the previously determined reference signals. In this example, the test signal is processed to compute the mean or average signal over a measurement or sampling period, such as one minute or more in this embodiment, and represented by block 820 (FIG. 8). The mean or average value is then normalized using the same normalization formula/value as used for the reference nodes, i.e. the mean value for six (6) operable cores in this example, as represented by block 830. The resulting normalized test nodes for the frequencies of interest are represented by test node 420 of FIG. 4 and test node 520 of FIG. 5.

As illustrated in FIGS. 4 and 5, test nodes 420, 520 typically will not “align” with any of the reference nodes for a variety of reasons such as measurement uncertainties in both the test node and the reference nodes, manufacturing variations, ambient noise variations, etc. As such, each test node signature is compared to corresponding reference node signatures as represented by block 840 (FIG. 8). In this embodiment, test node 420 is compared or matched against each reference node 400-410 using a Euclidean distance as represented by block 842 (FIG. 8). Similarly, test node 520 is compared or matched against each reference node 500-510 by determining corresponding Euclidean distances. This results in six distinct “distance” values for each frequency of interest corresponding to the distances between the test node and each of the six reference nodes. The reference node with the shortest distance to the test node is selected as the “match” to determine the number of operable cores in the IC being tested as represented by block 850 (FIG. 8). In this example, test node 420 is closest to reference node 410 indicating one (1) operable core. This is consistent with the result provided at the second frequency illustrated in FIG. 5 with test node 520 being closer to reference node 510 than any other reference nodes 500-508. Various strategies may be used to resolve any conflict between results associated with different frequencies depending on the particular implementation.

The previously described example processes results for each frequency independently and may be used where only one frequency of interest is employed. However, use of a single frequency or a small number of frequencies may not provide the desired confidence level in the result. Where multiple frequencies of interest are processed, the individual results may be used within a conflict resolution strategy to determine the number of operable cores of the test IC as previously described. Alternatively, signals associated with different frequencies of interest may be combined to reduce ambiguity in determining the number of operable cores and increase the reliability and repeatability of the determination to a desired confidence level.

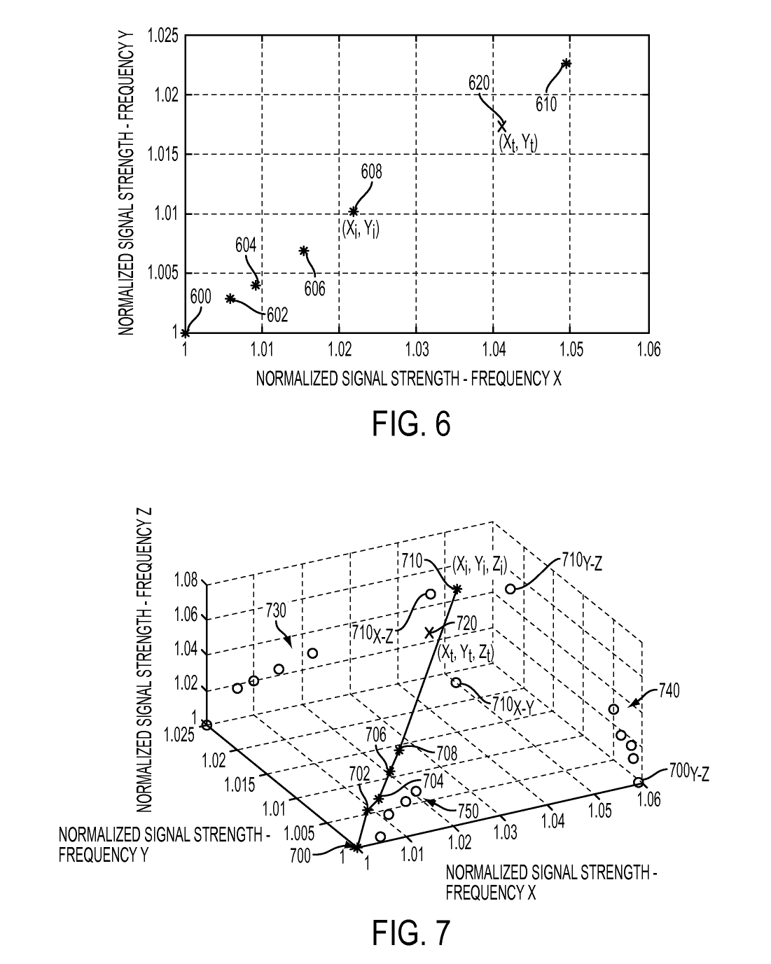

The normalized average power values for multiple frequencies can be combined to improve accuracy and provide unambiguous core-operability discrimination. For example, the normalized reference nodes of FIGS. 4 and 5 can be represented in a two-dimensional Euclidian space as illustrated in FIG. 6. The normalized reference nodes are plotted with a first frequency along the X-axis and a second frequency along the Y-axis. As such, reference node 600 corresponds to reference nodes 400, 500; reference node 602 corresponds to reference nodes 402, 502, and so on for reference nodes 604, 606, 608, and 610. This effective “spreading out” of the reference nodes in a two-dimensional (2D) Euclidian space reduces the likelihood that the uncertainty in adjacent nodes will be sufficient to create ambiguity when compared to the position of test node 620 in the X-Y plane.

The signature matching strategy described above can be extended to accommodate two or more frequencies. In a two-dimensional (2D) Euclidian power space, geometric distance between the test node and each of the reference nodes can be computed using the distance formula:

Dᵢ=[(Xᵢ−Xₜ)²+(Yᵢ−Yₜ)²]^{1/2}

where (Xₜ, Yₜ) are the cartesian coordinates for the test node, and (Xᵢ, Yᵢ) are the Cartesian coordinates for the reference nodes where i ranges from one to the number of cores (6 in this example). The number of operable cores is determined based on the shortest distance D, between the test node 620 and one of reference nodes 600-610, which is reference node 610 corresponding to a single core in this example.

To further improve discrimination robustness, a third frequency is added with the normalized power values plotted in an orthogonal dimension, as illustrated by reference nodes 700, 702, 704, 706, 708, and 710 of FIG. 7. A test node 720 may be plotted in a similar fashion with the number of operable cores determined by computing the geometric distance between the test node and each of the reference nodes according to:

Dᵢ=[(Xᵢ−Xₜ)²+(Yᵢ−Yₜ)²+(Zᵢ−Zₜ)²]^{1/2}

where (Xₜ, Yₜ, Zₜ) are the cartesian coordinates of the test node, (Xᵢ, Yᵢ, Zᵢ) are the Cartesian coordinates of the reference nodes where i ranges from one to the number of cores (6 in our example). The projections of nodes 700-710 onto the x-z plane are generally represented by points or nodes 730. The projections of nodes 700-710 onto the y-z plane are generally represented by points 740, with the projections onto the x-y plane generally represented by points 750. Representative sample points 710_{x-z}, 710_{y-z}, and 710_{x-y} correspond to the projections of node 710 in each plane.

As previously described, this strategy can be extended to provide an n-dimensional analysis for a corresponding number of frequencies of interest. In one embodiment, 20 distinct frequencies or frequency bins are used to determine a signature or fingerprint for the reference nodes and test nodes. The matching process includes determining a 20-dimensional Euclidean distance as a square root of the sum of the squares of the differences between the test node and each reference node. This yields distance values for each of the reference nodes (each corresponding to a known number of operable cores) with the smallest distance parameter uniquely identifying the number of operable cores in the test chip. Alternatively, or in combination, other multi-dimensional similarity measures may be used to select a reference node that is most similar to the test node to determine the number of operable cores in the test IC as previously described.

One or more weighting factors may be applied to adjust or modify the influence or contribution of signals at particular frequencies of interest. The weighting factors may be applied to determine the coordinates or signature of the reference nodes and test nodes prior to performing the pattern matching or comparison of the test node to each of the reference nodes. For example, in the 2-frequency embodiment illustrated in FIG. 6, a first weighting factor may be applied to the x-axis coordinates Xi and Xt with a second weighting factor applied to the y-axis coordinates Yi and Yt in determining the Euclidean distance between test node 620 and each reference node 600-610. The resulting distance calculation is then given by:

Dᵢ=[W₁(Xᵢ−Xₜ)²+W₂(Yᵢ−Yₜ)²]^{1/2}

where W₁ and W₂ are the weighting factors for the first and second frequencies, respectively, (Xₜ, Yₜ) are the cartesian coordinates for the test node, and (Xᵢ, Yᵢ) are the Cartesian coordinates for the reference nodes where i ranges from one to the number of cores (6 in this example). The number of operable cores in the test IC is determined using the smallest distance value as previously described. This strategy can also be extended to any number of frequencies and cores.

While 6-core chips have been used in the illustrated examples, the strategy is extendable to any number of cores and frequencies of interest. Similarly, while the illustrated examples employ a signature matching strategy based on a Euclidean distance of normalized signal levels, other matching strategies may be utilized. For example, pattern matching techniques using nonlinear, nonparametric pattern recognition, or correlation techniques may be used to determine the best match between the test node and one of a plurality of reference nodes. Similarly, in the representative embodiment illustrated in FIGS. 4-7, ratios are calculated by dividing the power levels after converting them to decibels (dB). Various other strategies may also be used. For example, in one embodiment, the ratios of the real power values are calculated and used in generating the ratios as illustrated in FIGS. 4-7. Use of the actual power levels instead of the ratio of decibels (dBs) provides a different perspective of separation between the power level of the noise for different numbers of processors for the “matching” and scaling math. However, the method of identifying the number of processors is the same for both of these alternative computational approaches for noise calibration.

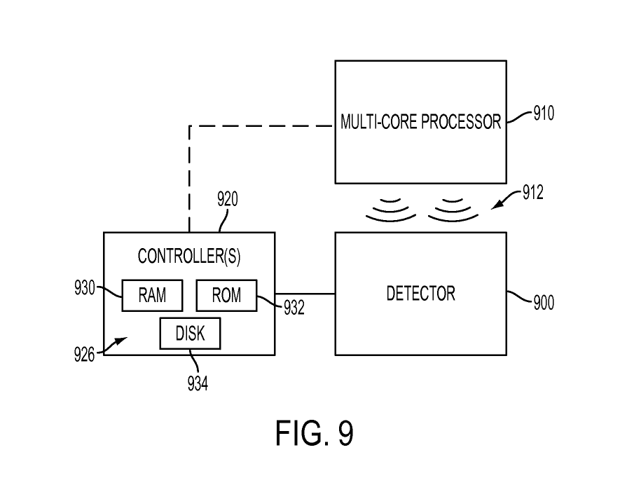

Referring to FIG. 9, a block diagram illustrating operation of a system or method for testing an IC according to the present disclosure is shown. An EM energy detector 900 (such as an antenna, wire, etc.) may be positioned in the vicinity of, or proximate to, a multi-core processor 910 to detect broadband radiated EM energy 912 generated by the multi-core processor 910 during operation. Positioning of detector 900 relative to processor 910, and the desired distance or proximity may vary depending upon a variety of application and implementation specific considerations such as the type of detector 900, the number of cores of processor 910, ambient noise within the test facility/location, etc. Detector 900 is coupled to at least one corresponding computer or controller 920 configured to determine a number of operable cores of multi-core processor 910 based on detected electromagnetic energy 912 radiated by processor 910 while processor 910 executes a specified set of instructions, or alternatively while at idle. As previously described, controller 920 may process a signal provided by detector 900 to determine an average signal strength of the radiated electromagnetic energy 912 associated with each of a plurality of predetermined frequencies. The controller(s) 920 may then compare this average signal strength data with corresponding reference values associated with a known number of functioning cores using predetermined average signal strength data representing differing numbers of operable (or inoperable) cores at similar frequencies or within corresponding frequency bins, bands, ranges, etc. A match identified by the controller 920 between a test node based on the measured signal and a reference node associated with a known number of operable (or inoperable) cores may be used to provide an output indicative of the number of operable (or inoperable) cores. This output may be, for example, displayed by a suitable display unit (not shown) or saved for later access.

As illustrated in FIG. 9, controller(s) 920 may optionally be coupled to processor 910 during testing to transfer one or more specified sets of instructions for execution during the test, or for initiating execution of previously stored instructions, for example. Alternatively, controller(s) 920 and detector 900 may form a stand-alone unit that does not contact processor 910.

Controller(s) 920 include or have access to one at least one computer readable medium 926, which may include various types of volatile and persistent storage, such as random access memory (RAM) 930, read-only memory (ROM), and optical, magnetic, or hybrid disk 934, for example. Computer readable storage medium 926 includes diagnostic instructions stored therein that, when executed by controller(s) 920 cause controller(s) 920 to process information associated with radiated electromagnetic energy 912 from multi-core processor 910 executing a specified set of test instructions to determine a number of operable cores of processor 910 based on the information. The diagnostic instructions may include instructions for determining power of the radiated electromagnetic energy 912 at each of a plurality of predetermined frequencies and instructions for comparing the power to a reference power at the predetermined frequencies associated with one or more reference multi-core processors having known numbers of functional cores as previously described. Similarly, computer readable medium 926 may include instructions for applying a weighting factor associated with each of the plurality of predetermined frequencies to corresponding information associated with the radiated electromagnetic energy 912. Computer readable medium 926 may also include diagnostic instructions for determining distance between a test data set associated with the radiated electromagnetic energy at the plurality of predetermined frequencies and each of a plurality of reference data sets associated with radiated electromagnetic energy for reference multi-core processors executing the specified set of test instructions each having a different known number of functioning cores. In one embodiment, computer readable medium 926 includes instructions for determining a test value corresponding to a weighted sum of average power for radiated electromagnetic energy at each of a plurality of frequencies.

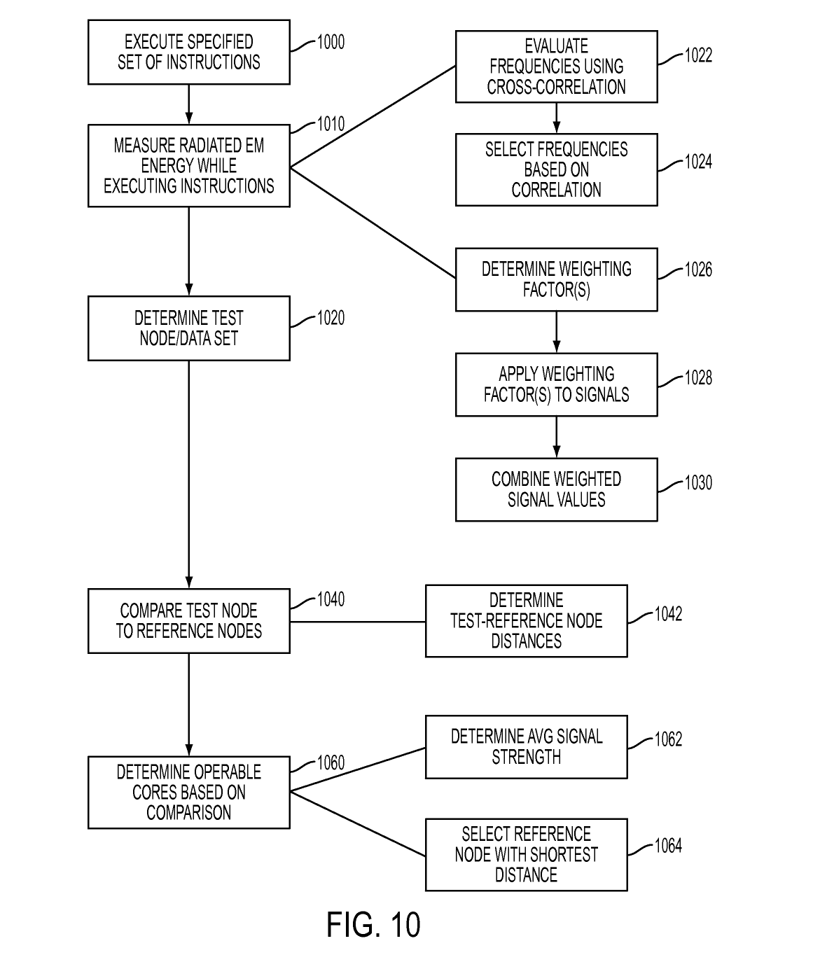

FIG. 10 is a block diagram illustrating operation of a system or method for testing an integrated circuit according to the present disclosure. Various embodiments of a system or method for testing an IC such as a processor having one or more functional blocks or cores may include executing a specified set of instructions using the processor as represented by block 1000. More than one instruction set may be executed depending on the particular application and implementation. As previously described, the specified instruction set may be selected to load the processor to provide a desired SNR for subsequent non-contact measurement of radiated EM energy. However, various types of processors may radiate sufficient EM energy signature or fingerprint at idle to provide a reliable indication of the number of functioning cores. Block 1010 represents measuring, sampling, and/or storing signals based on electromagnetic energy radiated from the multi-core processor while executing the specified set of instructions. Block 1020 represents determining a test node or data set corresponding to radiated power at each of a plurality of predetermined frequencies of the radiated electromagnetic energy. This may include processing of a broadband signal to identify average power within particular frequencies or frequency bands of interest. The predetermined frequencies or frequency bands may be determined by performing a cross-correlation of measurements of radiated electromagnetic energy at each of a second plurality of frequencies for a reference multi-core processor while executing the specified set of instructions relative to one another as represented by block 1022 and selecting frequencies based on the correlation as represented by block 1024. For example, frequencies with the best or highest correlation may be selected. Determining a test node or data set 1020 may also include determining a weighting factor 1026.

As previously described with reference to FIG. 3, determining a weighting factor as represented by block 1026 may include determining variance for radiated electromagnetic energy at a corresponding frequency for a reference multi-core processor while executing the specified set of instructions. In one embodiment, a weighting factor is determined by determining a normalized weighting factor based on an inverse variance of radiated electromagnetic energy for each frequency relative to an inverse of a sum of variances for all of the plurality of frequencies for the reference multi-core processor. The system or method may then apply a corresponding weighting factor to the average signal strength for each of the plurality of frequencies as represented by block 1028. In one embodiment, determining a test node as represented by block 1020 may also include combining weighted signal values for all of the plurality of frequencies as represented by block 1030.

As also illustrated in FIG. 10, various embodiments may include comparing the test node or data to each of a plurality of reference nodes or data with each reference node corresponding to a known number of operating cores of a reference multi-core processor executing the specified set of instructions as represented by block 1040. The comparison may employ various techniques or strategies for pattern matching or correlation as previously described. In one embodiment, comparing the test node to each of a plurality of reference nodes comprises determining a Euclidean distance between the test node and each reference node as represented by block 1042. The system or method may then determine a number of functional cores in the multi-core processor based on the comparison as represented by block 1060. In one embodiment, determining a number of operable cores 1060 includes determining average signal strength of the radiated electromagnetic energy at each of the plurality of frequencies as generally represented by block 1062. Where a Euclidean distance is used in the comparison represented by block 1060, the system and method may determine the number of functional cores by selecting the reference node closest to the test node based on the Euclidean distance as represented by block 1064.

The processes, methods, or algorithms disclosed herein may be deliverable to/implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The algorithms may also be implemented in a software executable object. Alternatively, the algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure and claims. As previously described, the features of various embodiments may be combined to form further embodiments of the invention that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes include, but are not limited to: cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method of testing a multi-core processor comprising:
executing a specified set of instructions using the multi-core processor;
measuring electromagnetic energy radiated from the multi-core processor while executing the specified set of instructions;
determining a test node corresponding to radiated power at each of a plurality of predetermined frequencies of the radiated electromagnetic energy; and
comparing the test node to each of a plurality of reference nodes with each reference node corresponding to a known number of operating cores of a reference multi-core processor executing the specified set of instructions to determine a number of functional cores in the multi-core processor.

2. The method of claim 1 wherein determining the number of operable cores of the multi-core processor includes determining an average signal strength of the radiated electromagnetic energy at each of the plurality of predetermined frequencies.

3. The method of claim 2 further comprising:
determining a weighting factor for each of the plurality of frequencies, wherein determining the test node comprises applying a corresponding weighting factor to the average signal strength for each of the plurality of frequencies.

4. The method of claim 3 wherein determining the weighting factor comprises determining variance for radiated electromagnetic energy at a corresponding frequency for a reference multi-core processor while executing the specified set of instructions.

5. The method of claim 4 wherein determining the weighting factor further comprises determining a normalized weighting factor based on an inverse variance of radiated electromagnetic energy for each frequency relative to an inverse of a sum of variances for all of the plurality of frequencies for the reference multi-core processor.

6. The method of claim 5 wherein comparing the test node comprises determining a correlation between the test node and each of the reference nodes.

7. The method of claim 3 wherein determining the test node comprises combining weighted signal values for all of the plurality of frequencies.

8. The method of claim 1 wherein comparing the test node to each of a plurality of reference nodes comprises determining a Euclidean distance between the test node and each reference node and wherein the number of functional cores is determined by the reference node closest to the test node based on the Euclidean distance.

9. The method of claim 1 further comprising selecting the plurality of frequencies by:
performing a cross-correlation of measurements of radiated electromagnetic energy at each of a second plurality of frequencies for the reference multi-core processor while executing the specified set of instructions relative to one another; and
selecting frequencies with the highest correlation.

10. A system for testing functionality of a processor, comprising:
a controller configured to determine a number of operable cores of the processor based on detected electromagnetic energy radiated by the processor while the processor executes a specified set of instructions.

11. The system of claim 10 wherein the controller determines an average signal strength of the electromagnetic energy corresponding to each of a plurality of predetermined frequencies.

12. The system of claim 10 wherein the controller compares the signal strength of the radiated electromagnetic energy associated with a plurality of predetermined frequencies to corresponding reference values associated with a known number of functioning cores.

13. The system of claim 12 wherein the controller applies a corresponding weighting factor to the signal for each of the plurality of frequencies.

14. The system of claim 10 further comprising an electromagnetic energy detector coupled to the controller and positioned to detect the radiated electromagnetic energy while the processor is executing the specified set of instructions.

15. The system of claim 14 wherein the controller determines a test node based on an average power level of the radiated electromagnetic energy at each of a plurality of predetermined frequencies by analyzing a signal received from the electromagnetic energy detector, and determines a Euclidean distance between the test node and each of a plurality of reference nodes associated with a known number of functioning cores.

16. A computer readable storage medium having diagnostic instructions stored thereon that, when executed by a computer, cause the computer to process information associated with radiated electromagnetic energy from a multi-core processor executing a specified set of test instructions to determine a number of operable cores of the multi-core processor based on the information.

17. The computer readable storage medium of claim 16 wherein the diagnostic instructions include instructions for determining power of the radiated electromagnetic energy at each of a plurality of predetermined frequencies and instructions for comparing the power to a reference power at the predetermined frequencies associated with reference multi-core processors having known numbers of functional cores.

18. The computer readable storage medium of claim 17 wherein the diagnostic instructions include instructions for applying a weighting factor associated with each of the plurality of predetermined frequencies to corresponding information associated with the radiated electromagnetic energy.

19. The computer readable storage medium of claim 17 wherein the diagnostic instructions include instructions for determining distance between a test data set associated with the radiated electromagnetic energy at the plurality of predetermined frequencies and each of a plurality of reference data sets associated with radiated electromagnetic energy for reference multi-core processors executing the specified set of test instructions each having a different known number of functioning cores.

20. The computer readable medium of claim 16 wherein the instructions include instructions for determining a test value corresponding to a weighted sum of average power for radiated electromagnetic energy at each of a plurality of frequencies.
